(19) United States
(12) Patent Application Publication
(10) Pub. No.: US 2007/0106958 A1
(43) Pub. Date: May 10, 2007

(54) Document management apparatus, document management program product, and computer-readable recording medium recorded with document management program

(75) Inventor: Hiroya Kumashio, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Ricoh Company, Ltd.

(21) Appl. No.: 11/594,402

(22) Filed: Nov. 7, 2006

(30) Foreign Application Priority Data
Nov. 8, 2005 (JP) 2005-323973

(51) Int. Cl. H04N 7/16; G06F 17/00

(52) U.S. Cl. 715/838; 707/104.1; 726/26

(57) ABSTRACT

In a document management apparatus for displaying information concerning documents accumulated therein, operation limitation information set to the documents is acquired, and an image showing contents of each of the documents based on the documents is generated. For each of the documents, an icon corresponding to an operation which is limited by the operation limitation information that is set to a document is synthesized with the image showing contents of the document. The image in which the icon is synthesized is displayed as a thumbnail image of each of the documents.

### PRIORITY

The present application claims priority to and incorporates by reference the entire contents of Japanese priority document 2005-323973, filed in Japan on Nov. 8, 2005.

### BACKGROUND OF THE INVENTION

1. Field of the Invention

The present invention generally relates to a document management apparatus, a document management program product, and a computer-readable recording medium recorded with the document management program, and more particularly to the document management apparatus, the document management program product, and the computer-readable recording medium with the document management program, in which information of documents accumulated in the document management apparatus can be displayed.

2. Description of the Related Art

Japanese Laid-open Patent Application No. 11-120202 discloses a technology in which file management software or a like for managing files and image data created by application software or a like includes a function for displaying each file by using image reducing contents of the file, so-called a thumbnail, when a list of files is displayed.

Since the list of files is displayed with using the thumbnails representing respective files, instead of using attribute items additionally attached to the files, a user can intuitively recognize the contents of each of the files.

However, in a case of displaying the list of the files by using the thumbnails alone (or the thumbnails and file names), it is difficult for the user to confirm security information being set to each file beforehand (prior to an operation of the files).

That is, the file management software and the like generally control an access with respect to each file in order to ensure security of each file.

For example, the PDF (Portable Document Format)™ of the Adobe company allows the user to set security information to a file itself. A PDF file can be encrypted and stored by setting a password (password for opening a document). Accordingly, a user who does not know the password is prohibited to view contents of the PDF file. In addition, in a case of distributing the PDF file, use of the PDF file against a purpose of a distributor can be limited.

However, the user cannot confirm the security of the PDF file until the user attempts to access the PDF file.

### SUMMARY OF THE INVENTION

A document management apparatus, document management program product, and computer-readable recording medium recorded with document management program are described. In one embodiment, a document management apparatus for displaying information concerning documents accumulated therein, comprises an operation limitation information acquiring unit to acquire operation limitation information set to the documents; a document image generating unit to generate an image showing contents of each of the documents based on the documents; an icon synthesizing unit to synthesize, for each of the documents, an icon corresponding to an operation which is limited by the operation limitation information set to a document with the image showing contents of the document; and a display controlling unit to display the image in which the icon is synthesized, as a thumbnail image of each of the documents.

### DESCRIPTION OF THE DRAWINGS

In the following, embodiments of the present invention will be described with e to the accompanying drawings.

FIG. 1 is a diagram showing a functional configuration of document management software implemented in a document management apparatus according to a first embodiment of the present invention;

FIG. 2 is a diagram showing an example of a document structure according to the first embodiment of the present invention;

FIG. 3 is a block diagram showing a functional configuration of the thumbnail creating unit according to one embodiment of the present invention;

FIG. 4 is a block diagram showing a hardware configuration example of the document management apparatus according the first embodiment of the present invention;

FIG. 5 is a flowchart for illustrating the process steps of a thumbnail image creating process executed by the document management software according to the first embodiment of the present invention;

FIG. 6 is a diagram showing a security icon example which is synthesized by corresponding to the operation limitation information, according to the first embodiment of the present invention;

FIG. 7A is a diagram showing a thumbnail image in a case in that all of a print operation, an edit operation, and a content extraction operation are allowed, according to the first embodiment of the present invention, and FIG. 7B is the thumbnail image in a case in that all of a print operation, an edit operation, and a content extraction operation are prohibited, according to the first embodiment of the present invention;

FIG. 8 is a flowchart for illustrating process steps of a thumbnail image creating process executed by document management software according to a second embodiment of the present invention;

FIG. 9 is a diagram showing an example of the thumbnail image for the file data to which the password is set, according to the second embodiment of the present invention;

FIG. 10 is a flowchart for illustrating process steps of a thumbnail image creating process executed by document management software according to a third embodiment of the present invention;

FIG. 11 is a diagram showing an example of the thumbnail image for the file data to which the content extraction is limited, according to the third embodiment of the present invention; and

FIG. 12 is a diagram showing a display example of a document list screen using the thumbnail image according to one embodiment of the present invention.

### DESCRIPTION OF THE PREFERRED EMBODIMENTS

According to one embodiment of the present invention, there is provided a document management apparatus for displaying information concerning documents accumulated therein, including: an operation limitation information acquiring unit to acquiring operation limitation information set to the documents; a document image generating unit to generate an image showing contents of each of the documents based on the documents; an icon synthesizing unit to synthesize, for each of the documents, an icon corresponding to an operation which is limited by the operation limitation information set to a document with the image showing contents of the document; and a display controlling unit to display the image in which the icon is synthesized, as a thumbnail image of each of the documents.

According to one embodiment of the present invention, when a list of the documents is displayed by using respective thumbnail images, it is possible for a user to properly recognize security information for each of the documents.

The above embodiments of the present invention can be achieved by a document management program product for causing a computer to conduct processes described above in the document processing apparatus or by a computer-readable recording medium recorded with a document management program.

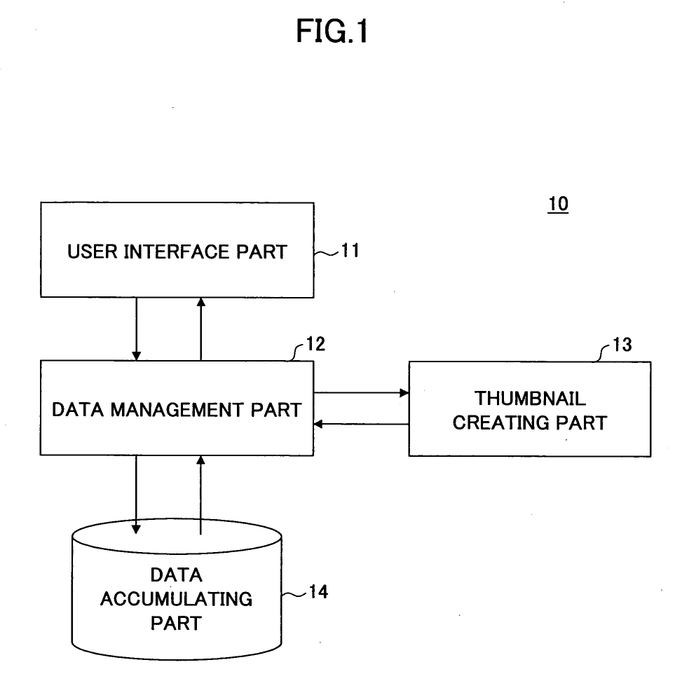

In the following, embodiments of the present invention will be described with reference to the accompanying drawings. FIG. 1 is a diagram showing a functional configuration of document management software implemented in a document management apparatus according to a first embodiment of the present invention.

In FIG. 1, the document management software in the document management apparatus 10 is software in which a management of an electronic document (hereinafter, simply called a “document”), and includes a user interface unit 11, a data management unit 12, a thumbnail creating unit 13, and a data accumulating unit 14, and a like.

The user interface unit 11 provides a GUI (Graphical User Interface) for browsing a list of documents or a like. The user interface unit 11 includes a function for displaying the list of the documents by using thumbnails (reduced images) of the documents.

The data management unit 12 provides interfaces for accessing the data accumulating unit 14 to the user interface unit 11 and the thumbnail creating unit 13.

The data accumulating unit 14 accumulates the documents in a storage area. In the first embodiment, a document is a file created by application software, an image file read by a scanner or received by a fax, or a like.

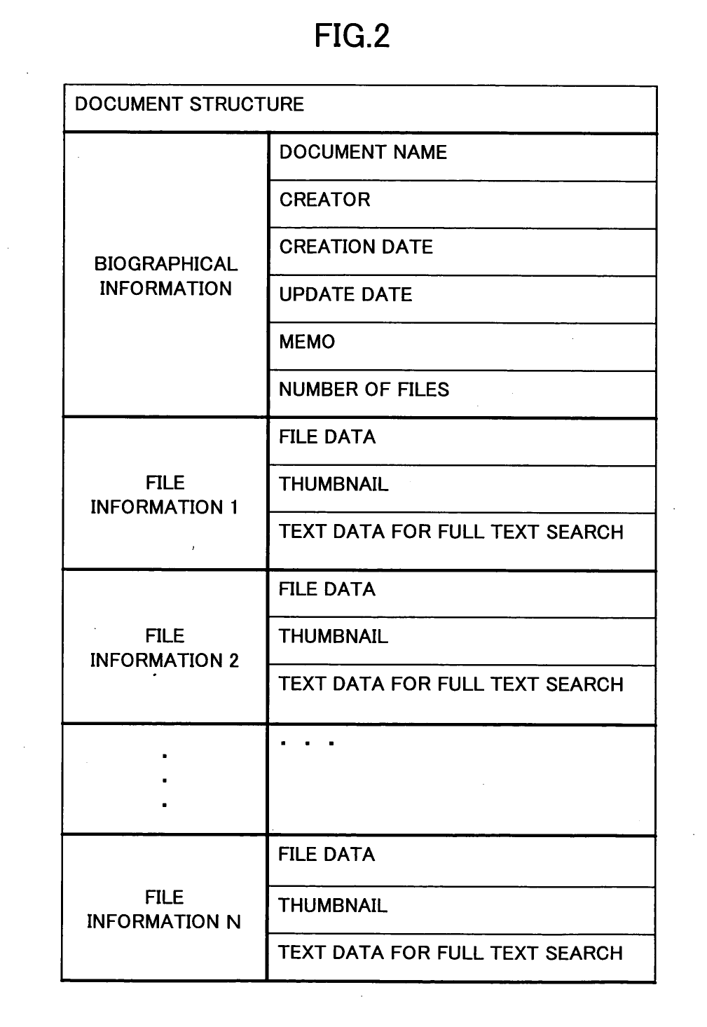

FIG. 2 is a diagram showing an example of a document structure according to the first embodiment of the present invention. In FIG. 2, the document structure of one document is shown in a tabular form. As shown in FIG. 2, the document according to the first embodiment of the present invention includes bibliographical information and file information (file information 1, file information 2, . . . , file information N) for each of files. The bibliographical information includes a document name, a creator, a creation data, an update date, a memo, a number of files (a number of sets of file information), and a like. Also, the file information includes a file data, a thumbnail data, a text date for full text search, and a like.

As described above, the document according to the first embodiment of the present invention is related to bibliographical items (the creator, the creation date, the update date, and the like) of the document, the thumbnail data, the text data for the full text search, and the like as additional data with respect to a document file (file data). The document is managed and accumulated. In addition, the document may include a plurality of document files.

It should be noted that a scope of application of the present invention is not limited to the document having the above-described document structure. The present invention can be applied to a system which manages each document as one file.

Referring to FIG. 1 again, the thumbnail creating unit 13 creates a thumbnail based on the file data. The thumbnail created by the thumbnail creating unit 13 is managed by relating to the file data.

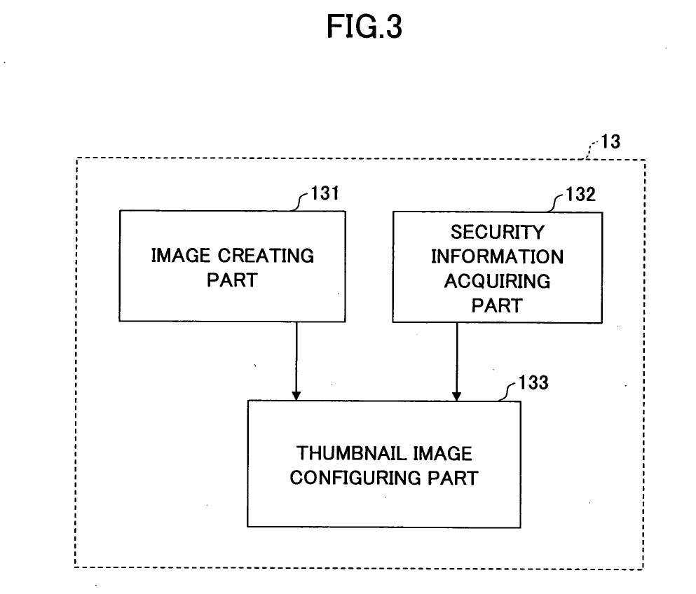

FIG. 3 is a block diagram showing a functional configuration of the thumbnail creating unit according to one embodiment of the present invention. In FIG. 3, the thumbnail creating unit 13 includes an image creating unit 131, a security information acquiring unit 132, and a thumbnail image configuring unit 133, and a like.

The image creating unit 131 creates an image from contents of a first page of the file data, and creates an image reducing the image created from the contents of the first page. The security information acquiring unit 132 acquires the security information (operation limitation information, information indicating a presence of a password for opening the document, and a like) set in the file data of the document. In a case in that the security information is information managed in an external storage area (for example, a security management server, an access control file, and a like) other then the file data, the security information acquiring unit 132 acquires the security information from the external storage area. In a case in that the security information is included in the file data, the security information acquiring unit 132 acquires the security information by accessing the file data. The thumbnail image configuring unit 133 overlays (synthesizes) an icon image (hereinafter referred to as a “security icon”) showing the security information acquired by the security information acquiring unit 132 with an image created by the image creating unit 131, and creates a thumbnail image as a final image.

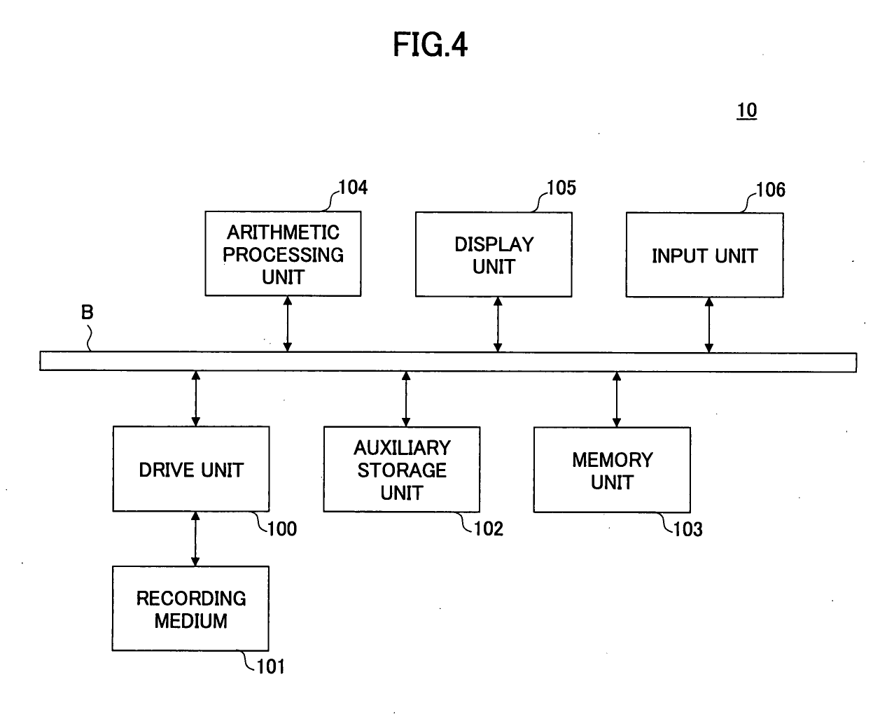

Next, a hardware configuration of the document management apparatus 10 will be described. FIG. 4 is a block diagram showing a hardware configuration example of the document management apparatus according the first embodiment of the present invention. The document management apparatus 10 shown in FIG. 4 includes a drive unit 100, an auxiliary storage unit 102, a memory unit 103, an arithmetic processing unit 104, a display unit 105, an input unit 106, and a like.

A program (document management software) realizing a process in the document management apparatus 10 is provided by a recording medium 101 such as a CD-ROM (Compact-Disk Read Only Memory) or a like. When the recording medium 101 recording the program is set to the drive unit 100, the program is installed to the auxiliary storage unit 102 from the recording medium 101 through the drive unit 100. The auxiliary storage unit 102 stores the program installed from the recording medium 101, and also stores image data or a like to be processed.

The memory unit 103 reads out and stores the program from the auxiliary storage unit 102 when an instruction is made to activate the program. The arithmetic processing unit 104 executes various functions concerning the document management apparatus 10 in accordance with the program stored in the memory unit 103. The display unit 105 displays various GUIs conducted by the program. The input unit 106 includes a keyboard, a mouse, and a like, and is used to input various operation instructions.

By connecting the document management apparatus 10 to a network, the document management apparatus 10 may be remotely operated from another terminal through the network. In this case, the drive unit 100, the display unit 105, the input unit 106, and the like may be mounted to another terminal. Thus, the document management apparatus 10 is not always required to mount these units 100, 105, 106, and the like.

In the following, process steps executed by the document management software of the document management apparatus 10 will be described.

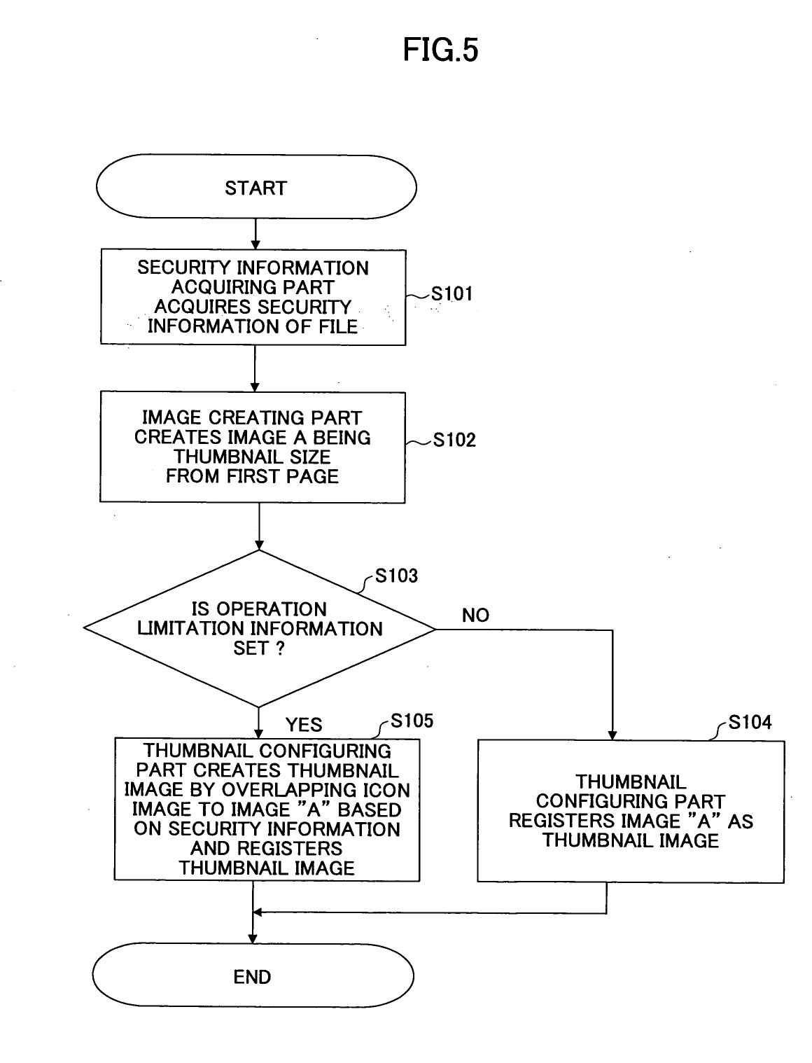

FIG. 5 is a flowchart for illustrating the process steps of a thumbnail image creating process executed by the document management software according to the first embodiment of the present invention. The thumbnail image creating process in FIG. 5 is executed when a new document or a new file is registered to the document management software, when contents of the file registered to the document management software is updated, and when the security information for the document is updated. In the following, the document to be processed is called a “subject document”.

In step S101, the security information acquiring unit 132 acquires the security information of the file data of the subject document. Subsequently, the image creating unit 131 creates image data (hereinafter, called an “image data A”) being a size for a thumbnail based on a first page of the file data (step S102). The thumbnail image configuring unit 133 determines whether or not the operation limitation information is set to the file data (step S103).

In the first embodiment, a case in which any one of a print operation, an edit operation, and a content extraction operation, or any combination thereof is limited will be exemplified. When the print operation is limited, it becomes impossible for file view software and a like to print out the file data. When the edit operation is limited, it becomes for the file view software and the like to edit the file data. When the content extraction operation is limited, it becomes for the file view software and the like to copy the contents of the file data.

When the operation limitation information is not set to the data file (YES in step S103), the thumbnail image configuring unit 133 relates the image data “A” as the thumbnail image of the file data to the file data, and registers the file data (step S104).

On the other hand, when the operation limitation information is set (YES in step S103), the thumbnail image configuring unit 133 creates a thumbnail image by synthesizing an icon image (security icon) corresponding to the operation limitation information with the image data “A”, relates the thumbnail image to the file data, and registers the file data (step S104).

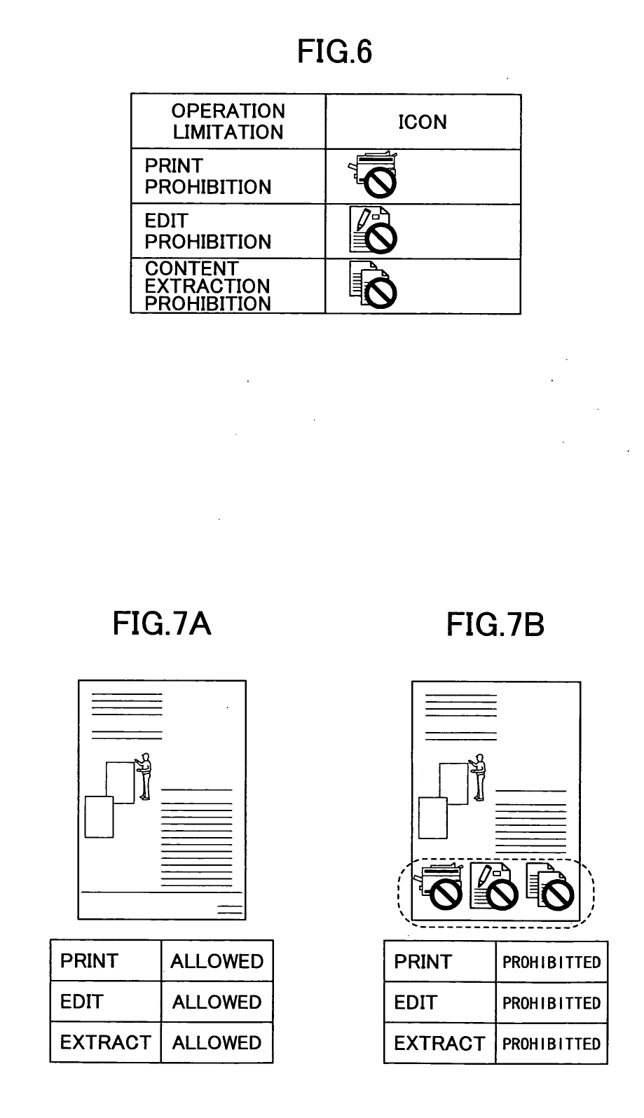

FIG. 6 is a diagram showing a security icon example which is synthesized by corresponding to the operation limitation information, according to the first embodiment of the present invention. As shown in FIG. 6, each security icon is shown so that an operation to be limited is visually depicted. It should be noted that in a case of simultaneously limiting a plurality of operations, a plurality of security icons are synthesized.

The thumbnail image created by corresponding to the operation limitation information will be described with reference to FIG. 7A and FIG. 7B. FIG. 7A is a diagram showing a thumbnail image in a case in that all of a print operation, an edit operation, and a content extraction operation are allowed. In this case, the security icon is not synthesized, and an image created based on the contents of the file data is used as the thumbnail image. FIG. 7B is the thumbnail image in a case in that all of a print operation, an edit operation, and a content extraction operation are prohibited. In this case, as shown in a region encircled within a dashed line, the security icons indicating respective operation limitations are synthesized in the thumbnail image.

It should be noted that the thumbnail image creating process in FIG. 5 is conducted for each set of file data in a case in that the subject document includes a plurality of sets of file data.

As described above, in the document management apparatus 10 according to the first embodiment, since the security icon is synthesized in the thumbnail, it is possible for a user to instantly recognize a setting state of the security. Accordingly, usability can be improved. That is, the user simply sees the thumbnail and recognizes the security information being set to a file without actually operating the file.

Next, a second embodiment in that the thumbnail image of the file data to which a “password to open” is set is generated will be described. The “password to open” (hereinafter, simply called a “password”) is a password to encrypt and store a file such as the PDF (Portable Document Format). When the user attempts to open the file, the user is required to input the password. Only the user who input a valid password can open the file. Accordingly, it is not appropriate to use image data of a predetermined page of the file data as the thumbnail of the file data to which the password is set. In addition, even the operation limitation information such as the print prohibition, the edit prohibition, the content extraction prohibition, and the like is prohibited to be acquired from the file data to which the password is set. The second embodiment will be described to solve the above-described problems. It should be noted that conditions of the document management apparatus 10 in the second embodiment are the same as the first embodiment unless otherwise stated.

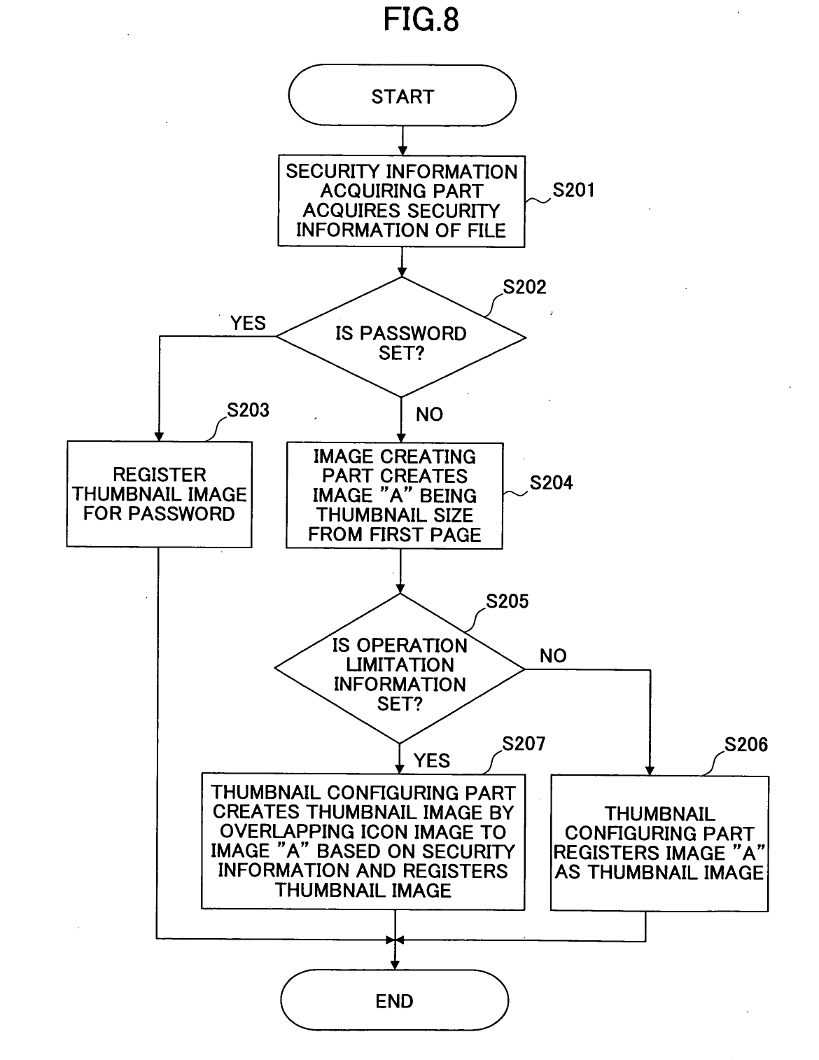

FIG. 8 is a flowchart for illustrating process steps of the thumbnail image creating process executed by document management software according to the second embodiment of the present invention.

In step S201, the security information acquiring unit 132 acquires security information of file data of a subject document. Subsequently, the thumbnail image configuring unit 133 determines whether or not a password is set to the file data, by accessing the file data (step S202). When the password is set to the file data (YES in the step S202), the thumbnail image configuring unit 133 registers an image, which is stored beforehand as a thumbnail image in a case in which the password is set to the file data, as the thumbnail image of the file data (step S203).

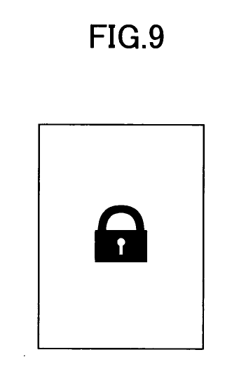

FIG. 9 is a diagram showing an example of the thumbnail image for the file data to which the password is set, according to the second embodiment of the present invention. In the step S203, an image having a user recognize that the password is set to the file data as shown in FIG. 9 is registered as the thumbnail image of the file data.

On the other hand, when the password is not set (NO in the step S202), in step S204, S205, S206, and S207, the same processes are conducted as processes in the step S102 through S105 in FIG. 5. Accordingly, when the operation limitation information is set to the file data, the image with which an icon corresponding to a limited operation is synthesized is set to the thumbnail image.

As described above, in the document management apparatus 10 according to the second embodiment, with respect to the file data to which the password is set, a predetermined image is used as the thumbnail image, instead of using the image based on the file data. Accordingly, while contents of the file data are prevented from being opened, it is possible for the user to intuitively recognize that the password is set to the file data.

It should be considered that in a case of the file data to which the operation limitation information indicates limiting content extraction, a process for creating the thumbnail imaging contents of the file data also corresponds to the content extraction to be limited. Thus, there is a case in that it is not appropriate to use the image based on the contents of the file data as the thumbnail. A third embodiment will be described to solve the above-described problems. It should be noted that conditions of the document management apparatus 10 in the third embodiment are the same as the first embodiment unless otherwise stated.

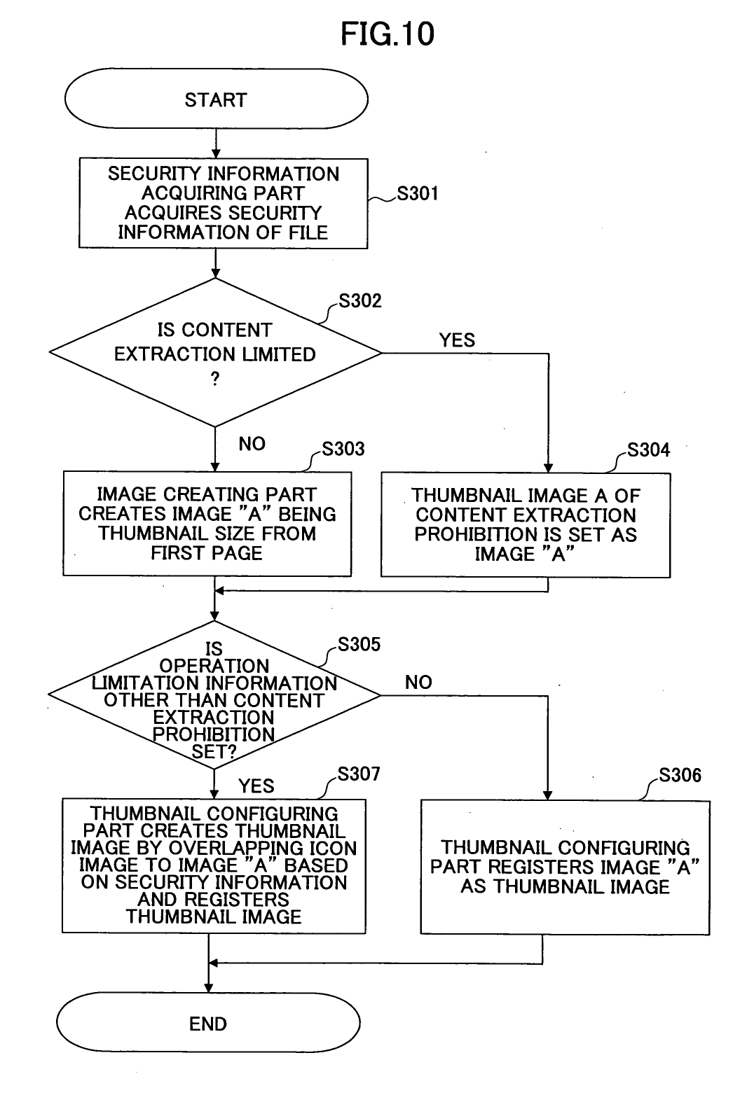

FIG. 10 is a flowchart for illustrating process steps of a thumbnail image creating process executed by document management software according to the third embodiment of the present invention.

In step S301, the security information acquiring unit 132 acquires the security information of the file data of the subject document. Subsequently, the thumbnail image configuring unit 133 determines based on the security information acquired by the security information acquiring unit 132 whether or not the content extraction is limited with respect to the file data (step S302).

When the content extraction is not limited with respect to the file data (NO in the step S302), in steps S303, S304, S305, S306, and S307, the same processes as the steps S102 through S105 in FIG. 5 are conducted. It should be noted that since it has been determined whether or not the content extraction is limited in the step S302, it is determined whether or not operations (the print operation and the edit operation) other than the content extraction are limited (step S305).

On the other hand, when the content extraction is limited with respect to the file data (YES in the step S302), the thumbnail image configuring unit 133 acquires an image, which is stored beforehand as the thumbnail image for the file data to which the content extraction is limited, as the thumbnail image for the file data (step S304).

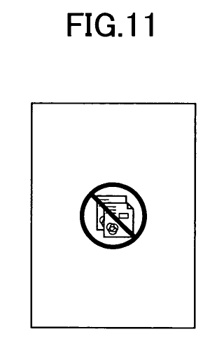

FIG. 11 is a diagram showing an example of the thumbnail image for the file data to which the content extraction is limited, according to the third embodiment of the present invention. In the step S304, the image having the user recognize that the content extraction is limited is acquired as shown in FIG. 11.

In the following, steps S305, S306, and S307 are conducted by setting the thumbnail image acquired in the step S304 as image data “A”. Accordingly, in a case of limiting other operations, icons indicating limitations of other operations are synthesized with the thumbnail image in FIG. 11 to form and register a final thumbnail image.

As described above, in the document management apparatus 10 according to the third embodiment of the present invention, with respect to the file data to which the password is set, a predetermined image is used as the thumbnail image, instead of using the image based on the file data. Accordingly, while contents of the file data are prevented from being extracted and opened, it is possible for the user to intuitively recognize that the content extraction of the file data is limited.

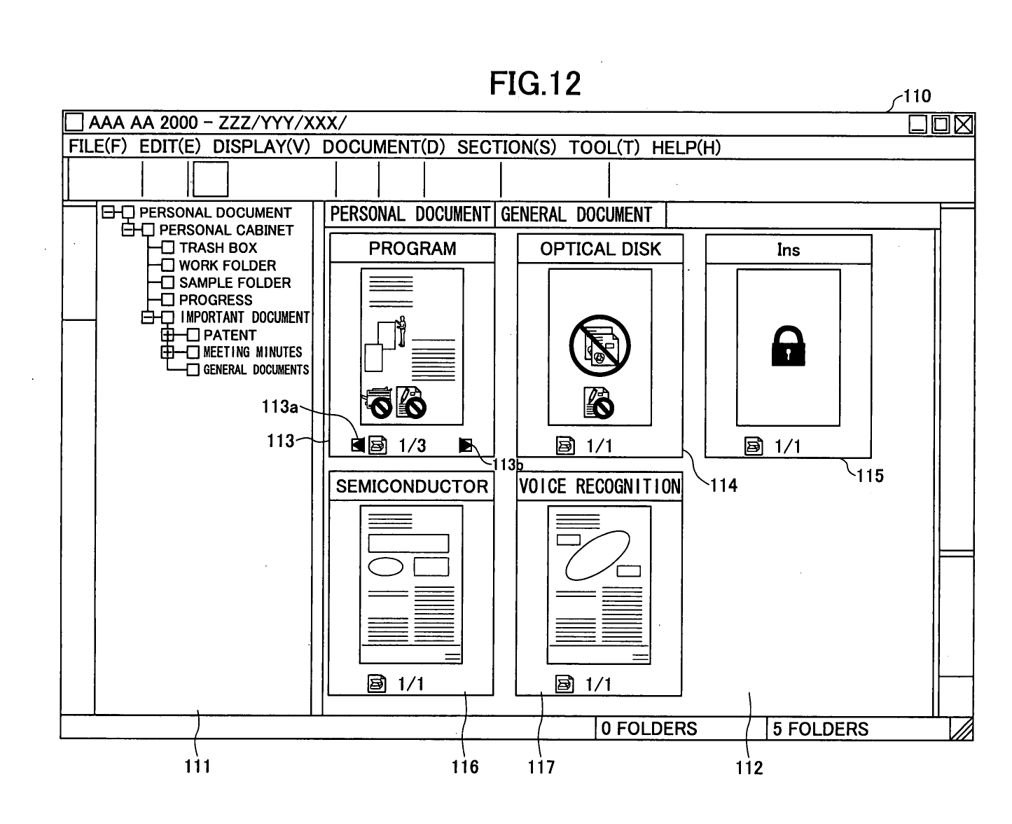

For example, the user interface unit 11 of the document management software displays a screen as shown in FIG. 12, by using the thumbnail image registered in the above-described processes in the first, second, and third embodiments.

FIG. 12 is a diagram showing a display example of a document list screen using the thumbnail image according to one embodiment of the present invention.

The document list screen 110 shown in FIG. 12 includes a folder display area 111 and a document list display area 112. The folder display area 111 is an area to display a tree structure of folders as storage locations of documents. The document list display area 112 is an area to display a list of documents stored in a folder selected in the folder display area 111. In FIG. 12, a rectangle area (hereinafter, called a “cell”) is given for each of the documents (cell 113 through cell 117), and a respective thumbnail image of the file data of each of the documents is displayed in each of cells 113 through 117.

For example, in the cell 113, the thumbnail image in which the security icon is synthesized is displayed. In the cell 114, the thumbnail image in which the security icon is synthesized is displayed for the file data to which the content extraction is limited. In the cell 115, the thumbnail image is set is displayed for the file data to which the password.

In the cell 113, a fraction number “⅓” is displayed below the thumbnail image, in order to show a total number of sets of the file data belonging to the document and a sequential number of the file data being currently displayed. Accordingly, the document corresponding to the cell 113 includes three sets of file data, and a first set of the file data is currently displayed. Moreover, the file data to be displayed can be changed (flipped) by operating a button 113a and a button 113b. The cell 113 newly displays the thumbnail image registered by executing the above-described processes in FIG. 5, FIG. 8, or FIG. 10 with respect to the file data.

In the first, second, third embodiments, the thumbnail image is generated based on the first page of the file data. Instead, the thumbnail image may be generated for each page, and the thumbnail image may be flipped for each page by an operation flipping sets of the file data. In this case, for each page, the security icon is synthesized with the thumbnail image corresponding to the data file, the thumbnail image for the file data to which the password is set is registered, and the thumbnail image for the file data to which the content extraction is limited is registered. Accordingly, in a case in that the thumbnail image for any one of pages is displayed, it is possible for the user to intuitively recognize the security information of the file data.

Moreover, it is not limited to realize the document management apparatus 10 by a single computer. The document management apparatus 10 can be realized as a document management system, so-called a client-server system.

The present invention is not limited to the specifically disclosed embodiments, and variations and modifications may be made without departing from the scope of the present invention.

The present application is based on the Japanese Priority Application No. 2005-323973 filed on Nov. 8, 2005, the entire contents of which are hereby incorporated by reference.

What is claimed is:

1. A document management apparatus for displaying information concerning documents accumulated therein, comprising:
an operation limitation information acquiring unit to acquire operation limitation information set to the documents;
a document image generating unit to generate an image showing contents of each of the documents based on the documents;
an icon synthesizing unit to synthesize, for each of the documents, an icon corresponding to an operation which is limited by the operation limitation information set to a document with the image showing contents of the document; and
a display controlling unit to display the image in which the icon is synthesized, as a thumbnail image of each of the documents.

2. The document management apparatus as claimed in claim 1, wherein the icon corresponding to the operation limited by the operation limitation information depicts at least one of a limitation of a print operation, a limitation of an edit operation, and a limitation of a content extraction operation.

3. The document management apparatus as claimed in claim 2, wherein the icon synthesizing unit synthesizes the icon with a predetermined image when a content extraction is included in operations to be limited by the operation limitation information.

4. A document management program product for causing a computer functioning as a document management apparatus to display information concerning documents accumulated in the computer, comprising code which, when executed by the computer, causes the computer to perform a method comprising:
acquiring operation limitation information set to the documents;
generating an image showing contents of each of the documents based on the documents;
synthesizing, for each of the documents, an icon corresponding to an operation which is limited by the operation limitation information set to a document with the image showing contents of the document; and
displaying the image in which the icon is synthesized, as a thumbnail image of each of the documents.

5. A computer readable recording medium recorded with a document management program, said document management program comprising code which, when executed by the computer, causes the computer to perform a method comprising:
acquiring operation limitation information set to the documents;
generating an image showing contents of each of the documents based on the documents;
synthesizing, for each of the documents, an icon corresponding to an operation which is limited by the operation limitation information set to a document with the image showing contents of the document; and
displaying the image in which the icon is synthesized, as a thumbnail image of each of the documents.
